(19) United States
(12) Patent Application Publication
(10) Pub. No.: US 2006/0078471 A1
(43) Pub. Date: Apr. 13, 2006

(54) Apparatus and method for a precision flow assay

(76) Inventors: Thomas R. Witty, Santa Cruz, CA (US); Robert Case, Henderson, NV (US); Scott Castanon, San Marco, CA (US)

Correspondence Address: HELLER EHRMAN LLP, 275 MIDDLEFIELD ROAD, MENLO PARK, CA, 94025-3506, US

(21) Appl. No.: 10/991,331

(22) Filed: Nov. 16, 2004

Related U.S. Application Data
(60) Provisional application No. 60/618,278, filed on Oct. 12, 2004.

(51) Int. Cl. B01L 3/00

(52) U.S. Cl. 422/100

(57) ABSTRACT

An apparatus is provided for testing fluid samples includes a sensor, which can be light source, directed to a flow cell and a photo sensor for detecting a light beam reflected from the flow cell. The photo sensor monitors the fluid in the flow cell by sensing the reflected light beam from the flow cell, thereby monitoring the test process. The flow cell has a flow channel the allows fluid sample to flow at a rate where sufficient incubation of the fluid will occur before the fluid enters an area where analyte levels will be detected.

### CROSS-REFERENCE TO RELATED APPLICATIONS

This application claims the benefit of U.S. Ser. No. 60/618,278 filed Oct. 12, 2004, which application is fully incorporated herein by reference.

### BACKGROUND OF THE INVENTION

1. Field of the Invention

The present invention relates generally to methods and systems for analyzing fluid samples and, more specifically, to methods and systems for using a flow channel to control sample fluid incubation.

2. Description of the Related Art

Blood and other body fluid tests are important diagnostic methods in patient care and treatment. The reliability and the accuracy of the tests are critical in correctly diagnosing the patient and administrating proper treatment. The Food and Drug Administration (FDA) has established numerous quality standards for the various blood or body fluid tests. Monitoring the test process is beneficial in producing reliable and accurate test results.

One way of monitoring the test process is periodically performing the monitoring test on standard test samples. The monitoring test results are compared with expected results to verify the accuracy of the test processes or correct the test instrument or process when appropriate. In this approach, the test processes are assumed to generate consistent result between the monitoring tests.

Another way of monitoring the test process is including standard test samples in the test process. This approach is suitable for a test process that performs tests on multiple samples. The test results on the standard test samples are compared with expected results to verify the accuracy of the test processes. In this approach, the test processes on real samples are assumed to generate result consistent with those on standard test samples.

These monitoring processes are time and cost inefficient. They are deficient in meeting the needs of point of care, e.g., emergency room, test processes. In addition to being reliable and accurate, an emergency room test process should be simple to operate and generate results fast.

Accordingly, it would be advantageous to have an apparatus and a method for monitoring a test process that is simple, and reliable. It is desirable for the test apparatus to be compact and capable of generating test results fast thereby meeting the need of the emergency rooms. It would be of further advantage for the apparatus and method to be easily adaptable for monitoring different test processes. Additionally, some tests require specific preparation of the fluid sample prior to testing. Some may desire certain incubation time before the fluid sample is tested. It would be advantageous to provide an apparatus and a method for properly preparing the sample for testing.

### SUMMARY OF THE INVENTION

An object of the present invention is to provide improved methods and systems for monitoring a test processes in real time.

Another object of the present invention is to provide methods and systems for monitoring test processes that performs a comparison of a timing of the introduction, and the exit of a sample to and from a measurement chamber, in order to confirm of a point in time of a valid reaction of the sample in the measurement chamber.

Yet another object of the present invention is to provide methods and systems for monitoring test processes that directly monitors the flow of a sample and a reagent into a measurement chamber.

A further object of the present invention is to provide methods and systems for monitoring test processes in a flow cell that in real time sense the flow a sample or a reagent without relying on information that originates outside the flow cell.

These and other objects of the present invention are achieved in a flow cell configured to be fluidly coupled to a fluid moving source and utilized with a monitor device the flow cell includes a housing, a mixing chamber and a flow channel. The flow channel is sized to provide for movement of liquid from the mixing chamber by non-capillary action. A matrix is positioned at a distal end of the flow channel. The matrix contains a compound that will react with the sample to create a change detectable by the monitor device. A fluid path extends from the mixing chamber to the flow channel and to the matrix to bring sample fluid to the matrix for the detection of analyte levels.

In another embodiment of the present invention, a flow cell is configured to be fluidly coupled to a fluid moving source and used with a monitor device. The flow cell includes a housing, mixing chamber, flow channel and a matrix. The matrix is positioned in the mixing chamber. A fluid path extends from the mixing chamber to the flow channel. The flow channel is sized to provide for non-capillary fluid flow.

In another embodiment of the present invention, a test device is provided that has a non-microporous mixing chamber. A flow channel is coupled to the mixing chamber. A matrix is in fluid communication with the flow channel. The matrix contains a compound that will react with the sample to create a change detectable by a monitor device. A fluid path extends from the mixing chamber to the flow channel and to the matrix to bring sample fluid to the matrix for detection of analyte levels.

### BRIEF DESCRIPTION OF THE DRAWINGS

FIG. 1 illustrates an apparatus for performing a test on a fluid sample in accordance with the present invention.

FIG. 2 shows a cross-sectional view of one embodiment of a flow device according to the present invention.

FIG. 3 is a perspective view of another embodiment of a flow device according to the present invention.

FIGS. 4 and 5 show cross-sectional views of the device shown in FIG. 3.

FIG. 6 is a perspective view of yet another embodiment of a flow device according to the present invention.

FIG. 7 is a perspective view of a still further another embodiment of a flow device according to the present invention.

FIG. 8 shows a cross-sectional view of the device shown in FIG. 7.

### DETAILED DESCRIPTION OF VARIOUS EMBODIMENTS

Various embodiments of the present invention are described hereinafter with reference to the figures. Elements of like structures or function are represented with like reference numerals throughout the figures. The figures are only intended to facilitate the description of specific embodiments of the invention. They are not intended as an exhaustive description of the invention or as a limitation on the scope of the invention. They are not necessarily drawn to scale. In addition, an aspect described in conjunction with a particular embodiment of the present invention is not necessarily limited to that embodiment and can be practiced in conjunction with any other embodiments of the invention.

In one embodiment, the present invention provides a flow cell configured to be coupled to a fluid moving source, including but not limited to a pump. An open flow channel is provided where fluid is moved at a precise rate. Fluid in the open flow channel does not move on its own without action of a fluid moving source. The open flow channel can be sized so that it does not have capillarity flow and does not draw a sample forward without the flow provided by the fluid moving source. Flow cell can be disposable flow cell and mate to a cartridge that delivers the sample from a vacutainer through a sample introduction port. An operator can attach the vacutainer to a larger cartridge to begin the flow.

Vacuum can be used to pull the sample through the flow cell. Pressurize can be utilized to push the sample through. In one embodiment the pressure is about 1 psi. A standard flow detector can be utilized for sensing when a sample, including but not limited to blood, has reached the flow cell, since there may be a variation in head space in the vacutainer tube. The process of inserting on the large cartridge neutralizes the pressure. It starts at atmospheric pressure so there is not any unexpected movement in or out of the tube. Because the headspace can vary (depending on a full draw or partial draw), when that headspace needs to be compressed before starting movement, there can be a variable time lag. A flow detector can be used to account for any variation in timing to get the fluid flowing.

Background signal can be removed. Sample can continue flowing into a matrix to deplete a solid phase label (so no more label is left to detect). The sample can be used as a wash or the sample can be followed with a chaser wash to lower the background noise.

In one embodiment, a system is provided that uses a dry reagent in a fluid moving source, metered system. Embodiments of the present invention can use a flow cell with a dry reagent, where the flow cell is used with the fluid moving source system. By way of illustration, and without limitation, fluorescent beads can be utilized because they are more stable than a fluorescent molecule. A hydrophobic membrane can be used to contain an immobilized antibody.

In one embodiment, a method is provided that brings reagents into proximity. The incubation time is controlled by the flow rates. Incubation time can be controlled without varying the structure of the device used. Changing the flow rate will change the incubation times. Temperature can also be controlled on the flow cell. Thermal devices can be placed along or adjacent the flow path to regulate temperature.

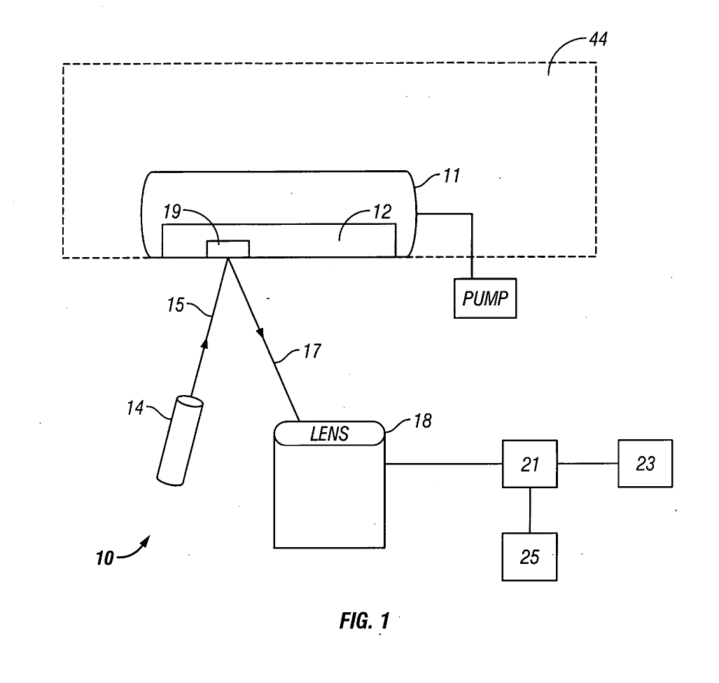

FIG. 1 is a schematic diagram of an apparatus 10 for performing a test on a fluid sample in accordance with the present invention. In accordance with one embodiment, apparatus 10 is used for performing tests on blood samples or other fluids. The blood tests may be hematology tests, chemistry tests or immunology tests that provide valuable information in diagnosing such conditions as viral infection, bacterial infection, blood loss, heart attack, pregnancy, hormonal disorders, metabolic status, neuronal damage, cancer, cellular function, genetic information, electrolyte balance, blood clotting, drug monitoring, toxicology and the like.

In accordance with the present invention, apparatus 10 is capable of monitoring the blood test process on an effective real time basis without relying on extrinsic information such as the test results of standard samples or secondary process monitoring such as motor position detection.

Apparatus 10 includes a flow cell holder 11 for holding flow cell 12. During a test, the sample flows through flow cell 12. In one embodiment, a reactive antibody specific to an analyte in the test is coated on the surface of flow cell, 12 during the production of flow cell 12. For each test, a new flow cell 12 is placed on flow cell holder 11. A sensing of a sample or a reagent is provided in real time without relying on information that originates outside flow cell 12. The external monitoring information can include a mechanical, electrical or photo event within apparatus 10 external to flow cell 12. By way of illustration, and without limitation, the mechanical information can include fluid moving source information such as pump driver movement, pneumatic movement of air, valve encoder rotation within apparatus 10, electrical sensing of a sample in a sampling device such as by a needle or other capillary, and the like.

For purposes of this specification, in real time means a frequency of measurement to insure that the reaction in a selected time period has taken place. By way of example, and without limitation, the selected time period can be 10% or less of the overall time period step or process in the reaction. By way of illustration, and without limitation, in real time can be in the range of 1 second to 1 minute, and the like, depending on the analyte and process involved.

Flow cell 12 can also include at least one reactive binding partner, including but not limited to an antibody and the like. The reactive binding partner can be any material that can specifically bind the analyte directly or indirectly. The reactive antibody can be present on a surface of flow cell 12, in a flow path of flow cell 12 (which can be in the form of on a membrane, on particles immobilized in the flow path, and the like. The reactive binding partner can immobilized in a flow path of flow cell 12. Samples and/or reagents are into flow cell 12, The reagent can be a calibrant, a fluid containing reactant, a fluid not containing a reactant, a sample, and the like.

For optical detection ease, one or more dyes can be included and mixed with the reactive binding partner. Electrical and other means of sensing can be aided with other non-interfering additives. The inclusion of dye base line image data with different characteristics can be utilized. By way of illustration, and without limitation, the different characteristics can be different in intensity, frequency, magnetic field or other measureable property.

Apparatus 10 also includes an energy source 14 that can be positioned adjacent to flow cell holder 11 Energy source 14 can be a variety of different sources including but not limited to electrical, mechanical, optical (both coherent and incoherent light), RF, resistive heating, ultrasound, magnetic, and the like. A sensor 18 is positioned to receive an output from flow cell 12.

When energy source 14 is optical, energy source 14 can be a LED, LED array and coherent light source. Suitable LED's include but are not limited to, white, red, green, blue source, and the like. An electromagnetic field can also be utilized. As a light source, energy source 14 can be positioned to project an incident light beam 15 towards flow cell 12. In response to the activity in flow cell 12, a light beam 17 is reflected from flow cell 12. More than one light source 14 can be used. Multiple light sources 14 can be employed to monitor different test processes using image data formed from different light beams.

In one embodiment, flow cell 12 includes a measurement chamber 19. A monitor device 21 directly monitors and produces a signal indicative of an introduction and an exit of at least one of a sample or a reagent to and from measurement chamber 19. Logic resources 23 receive the signal and performs a comparison of a timing of the introduction and the exit of the sample to and from measurement chamber 19. This produces a confirmation of a point in time of a valid reaction of the sample in measurement chamber 19. The validity of the reaction is defined by the juxtapositioning of two or more reagents in a timeframe that has been determined to be sufficient for full and complete reaction.

Flow cell 12 includes an inlet, an outlet and a channel coupled to measurement chamber 19. Inlet is configured to provide for introduction of the sample into the inlet by a variety of means including but not limited to, laminar flow, absorption, with the use of a pumping force (displacement, either positive or negative pressure) gravity, centrifical force, pneumatic movement, and the like.

In one embodiment, flow cell 12 includes bibulous materials. At least a portion of the flow of flow cell 12 can be induced by the bibulous material and is open to the atmosphere. Flow cell 12 can also include non-bibulous materials. In one embodiment, the non-bibulous materials include a surface that has measurement chemistry and a second surface that is filled to the first surface. The second surface provides a window viewable by the sensor, optically or electronically.

A variety of sensors 18 can be utilized, including but not limited to a, photo sensor, charge coupled device, photo detector or array, PMT, CMOS, and the like.

Sensor 18 can be coupled to a digital image processing circuit. Sensor 18 is used to detect changes of the sample in measurement chamber 19. Such optical changes include but are not limited to, light reflection characteristics, light absorption characteristics, and light fluorescence characteristics. Electrical changes include but are not limited to conductance, capacitance, impedance, magnetic disturbances, and the like. In one specific embodiment, sensor 18 is a charge coupled device (CCD) photo detector array coupled to a digital image processing circuit 25. Sensor 18 may also include a light beam focusing lens in front of the CCD photo detectors 18.

Energy source 14 produces an output of energy that interacts with measurement chamber 19. Sensor 18 is positioned to receive an output from flow cell 12. The output can be light intensity, a measurement of wavelength, a measurement of electric capacitance, a measurement of conductivity, impedance and/or magnetic field, and the like.

Monitor device 21 can include energy source 14 and/or sensor 18. Monitor device 21 can directly monitor a progress of events inside measurement chamber 19. This progress of events in measurement chamber 19 includes but is not limited to, sample introduction, calibrant introduction, sample wash out, calibrant displacement, reagent introduction, and the like. In one embodiment, the preceding in the prior sentence occur in a determined order and timing sequence that is dependent on the assay and sensor type.

In one embodiment, monitor device 21 provides an indication of a response of the sample to a mechanical change of apparatus 10. Such a mechanical change can include, but is not limited to, movement of a pump to create a flow of sample or reagent, pneumatic movement, movement of a reaction area in measurement chamber 19, movement of measurement chamber 19, a mechanical response relative to a secondary reaction in measurement chamber 19, sensing of a fluid entrance or displacement in the chamber and the like.

In one embodiment, monitor device 21 detects changes in measurement chamber 19, and in response to the changes, determines if there is a sufficient amount of at least one of sample, reagent, calibrant, and the like in measurement chamber 19.

Logic resources 23 can implement a variety of different QC protocols for apparatus 10 including but not limited to, optical measurement to assure wetting of a strip test area at a selected time, optical measurement to assure wetting of a strip test area in measurement chamber 19 at a selected time following application of pressure to a sample pressurization, optical measurement of flow path to assure sample movement to specific point in a flow path at predetermined time from sample pressurization, optical measurement of a flow path to assure sample removal from a specific point in a flow path and replaced by a diluent at a predetermined time from dilutent pressurization, optical measurement of an assay cell in measurement chamber 19, optical measurement of an assay cell in measurement chamber 19 to assure that diluted sample arrives at a selected measurement region and at a selected time from mixed sample pressurization, electrical measurement of an assay cell to assure that a calibrant has sufficiently filled measurement chamber 19, electrical measurement of an assay cell to assure that a calibrant has sufficiently filled measurement chamber 19 by a selected time from calibrant pressurization, electrical measurement of the assay cell to assure that the sample has sufficiently filled the chamber by a selected time from sample accualization, mechanical changes, such as pressure, weight and the like, that can be measured electronically, and the like. Additional details of the system may be found in commonly assigned, copending U.S. patent application Ser. No. 10/845,767, filed May 14, 2004 and fully incorporated herein by reference for all purposes. It should be understood the flow cell 12 may be fluidically coupled to a fluid moving device, including but not limited to * such as but not limited to a pump to push fluid through the flow cell. In some embodiments, fluid may be “pulled” through the flow cell through the use of suction pump or vacuum * to draw fluid in such a manner. It should be understood that the flow cell 12 may be formed to fit within a larger cartridge 44 (shown in phantom).

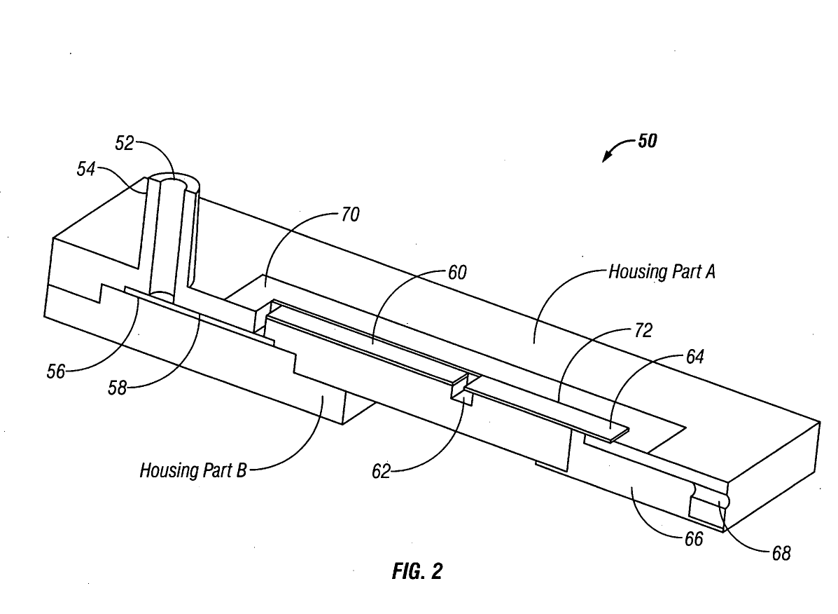

Referring now to FIG. 2, one embodiment of a flow cell 50 will now be described in further detail. FIG. 2 shows a cross-sectional view of the flow cell 50. In this present embodiment, the flow cell 50 includes a sample introduction port 52 for receiving sample fluid. By way of example and not limitation, the introduction port 52 may or may not have a shaft portion 54. Fluid received from the port 52 will be received in a chamber 56. By way of example and not limitation, the chamber 56 may be a solid phase label mixing chamber with or without a matrix 58. The matrix 58 may contain labeled reagent for binding with the sample fluid. The binding agent may be on the chamber wall or in some embodiments, it may be in the matrix which may be a glass fiber structure. Glass fiber may be used for the immobilized, solid phase antibody. The glass fiber allows the use of a larger surface area and it may be easier to force the sample through that type of structure. The fluid contact can be extended by stopping the flow or mixing enhanced by increasing the rate or flow through a tortuous path in order to maximize sample/label mixing interaction.

In one embodiment of the present invention, separation of the cells from whole blood before flowing into flow cell is performed. In another embodiment of the present invention, non cell containing samples, including but not limited to serum, plasma, urine, CSF and the like, are utilized.

As seen in the embodiment of FIG. 2, the flow cell 50 includes a precision dimensioned flow channel 60 that receives fluid from the chamber 56 at a rate a rate precisely controlled by force applied by the fluid moving source which can be speed. In one embodiment of the present invention, precision control results in less than a 10% variation in flow rate and thus a transit time through the precision flow channel 60 based on pumping mechanism control, Precision control can be achieved with devices and schemes that control the flow rate, the force that is applied to a fluid, and the like. The flow channel 60 leads to a flow control chamber 62. From the flow control chamber 62, fluid sample flows into an immobilized antibody matrix 64. The matrix 64 is coupled to a sample overflow chamber 66. As seen, a vent or exit port 68 can be provided and used to provide suction to draw or pull fluid so that it flows through the flow cell. A clear film window 70 may be used to cover the precision flow channel 60 and the matrix 64. The clear window allows for fluorescence or other indicator from the matrix 64 to be detected. It will be appreciated that the other indicators utilized can include, but are not limited to, color, magnetic property change, chemi-luminescence and the like. In some embodiments, the entire matrix 64 may fluoresce. In other embodiments only a front portion may fluoresce. Still other embodiments different areas of the matrix 64 may fluoresce.

By way of example and not limitation, when the flow cell 50 is in use, a sample aliquot is moved, such as by pumping action, from the sample chamber into the chamber 56 containing the solid phase labeled antibody. In one embodiment, without the pump, no sample would flow and the process described below could not occur.

The labeled antibody is thoroughly mixed with the sample using precision pumped flow through a mixing matrix. The resulting mixture is pumped to a flow channel 60 wherein it is flowed under the control of the fluid moving source at a precise rate so as to control binding of the analyte contained in the sample with the labeled antibody. In one embodiment, without the fluid moving source, the channel is sized so that the mixture would not flow through this channel.

In some embodiments of the present invention, the fluid flows rapidly into the mixing chamber 56 and flows slower in the chamber itself (but at a faster rate than it flows down the open channel 60). In the essence, the fluid flowing through the channel 60 is the time when the antigen in the sample is binding to the labeled antibody. This is controlled precisely to allow for adequate incubation time. It flows at a very slow rate through the precision flow channel 60. In one embodiment of the present invention, the flow rate is about 2-15 ul/sec

In one embodiment of the present invention, upon exiting the precision flow channel 60, the mixture is forced by the fluid moving source into a flow control chamber 62 wherein further mixing occurs due to the turbulent flow to assure homogeneity. Also, this chamber 62 is constructed in such a way so as to also force the flow of the reacted mixture into the portion of the flow-cell containing an immobilized antibody on a high surface area matrix.

The reacted mixture flows through the matrix 64 in intimate contact with materials therein, such as but not limited to immobilized antibody. The analyte in the sample which has bound to the labeled antibody during the precision flow step, additionally becomes bound to the immobilized antibody. Further sample, essentially free from any labeled material is then forced through the matrix to reduce any non-specific binding in the fluorescence zone. This excess mixed and unmixed sample is moved, such as by pumping action, into an empty sample overflow chamber. In some embodiments, without the fluid moving source, the washing and flow into the sample overflow chamber would not occur.

This fluid moving source, induced flow process produces a detectable intensity level of fluorescence when illuminated by the proper wavelength of light through the material covering all four sides of the fluorescent zone. By way of illustration, and without limitation, when a pump is utilized, as the fluid moving source, the pump pressure is sufficient to maintain a flow rate through the fluorescent zone can be about 0.5-5 cm/min. At least one side of the fluorescent area 72 is covered by a clear window. The intensity of this fluorescence is measured through the window and compared to the intensity produced by this process using know concentrations of the analyte. Comparison with the unknown sample's intensity allows quantitation of the level of analyte it contains. In one embodiment, the fluorescence area is contained on all four sides to function as described and the label is invisible without specialized optics.

The flow control chamber 62 will break any possible capillary attraction since it is much larger than an area that the flow would usually bridge and can depend on the liquid and wettability of the surface. Flow control chamber 62 is dimensionally larger than an area that supports capillary flow regardless of the liquid and wettability of the surface of flow control chamber 62. By way of illustration, and without limitation. In one embodiment, flow control chamber is 1-10 mm deep Additionally, the flow control chamber 62 functions to mix conjugate (presumably bound to antigen in the sample) before it enters the immobilized antibody area. It also allows for fluid to be forced into portions of the matrix 64 that overhang the chamber 62, since that may provide a greater exposed area for fluid contact.

One challenge of the present invention involves flowing fluid from an open channel into a partially occluded area (holding the immobilized antibody). The chamber 62, as described above, may be used to address this challenge. The use of flow control chamber 62 is one method to force liquid into the occluded area (which may be a hydrophobic material). To gain surface area, a matrix like polypropylene may be used and that creates a blockage of flow. Fluid is forced in the matrix to interact with the immobilized antibody.

The chamber 62 exposes a greater surface area of the matrix, allowing for forcing into the matrix 64. Since the area is sealed, unlike most lateral flow devices, pressure may be exerted to force fluid into the matrix 64. The overhang of the matrix 64 provides greater surface on which pressure may be exerted.

Various materials, various thickness, and some may use just the surface of the flow cell. Flow control chamber will depend on selection of the media.

Some embodiments of the present invention may eliminate the conjugate matrix 58 and chamber 56. The chamber 56 could, instead, be part or area of larger cartridge where conjugate is introduced and mixed with sample. The mixture may then be flowed directly to the precision flow channel. The present invention may have a mixing chamber that is not part of the flow cell and part of another device.

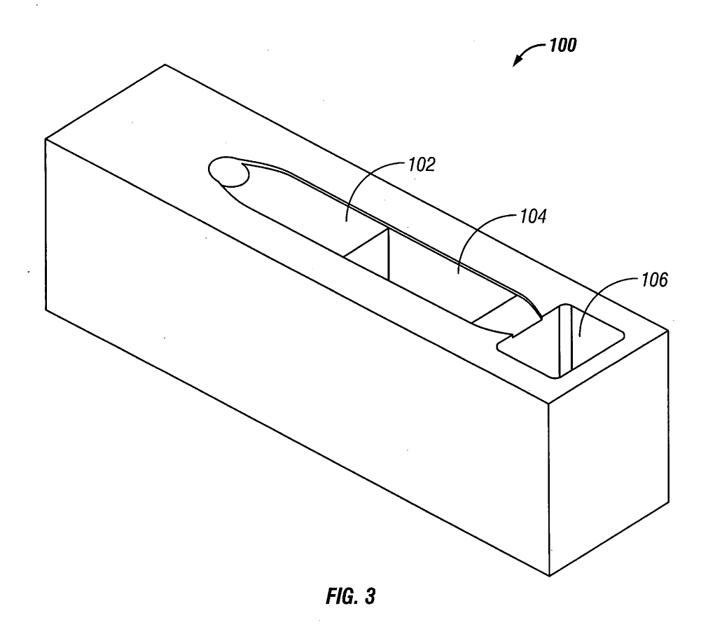

Referring now to FIG. 3, a still further embodiment of a flow cell 100 will now be described. FIG. 3 provides a perspective view of a top surface of the flow cell 100. As seen in FIG. 3, the flow cell 100 includes a precision flow channel 102 which leads to an immobilized antibody chamber 104. It should be understood that the chamber 104, in other embodiments, may contain other materials besides antibody, for detecting analytes. The chamber 104 will allow fluid to flow into sample overflow chamber 106.

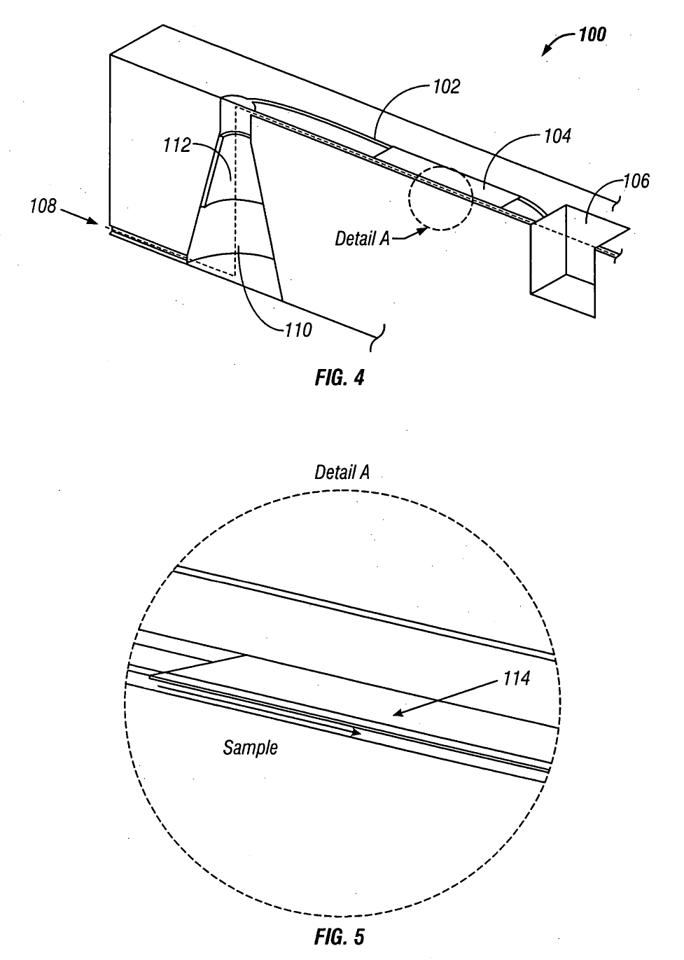

FIG. 4 shows a cross-sectional view of the embodiment shown in FIG. 3. As seen in FIG. 4, sample fluid enters at location 108. It flows into a mixing chamber 110. By way of example and not limitation, the mixing chamber 110 may be a vortex mixing chamber. Other embodiments may use chambers of other geometries or cross sections such as oval, round, triangular, rectangular, polygonal or any single or multiple combinations of the above. The mixing chamber 110 may have dry reagent or other material that is located along a portion 112 of the chamber 110. In some embodiments, the reagent may be sprayed on to the surface of the chamber 110. Other embodiments may use layers adhered to the chamber 110. Other may have the entire chamber surface coated with reagent or label. Other embodiments may have geometric patterns on the surface of chamber 110. Geometries such as oval, round, triangular, rectangular, polygonal or any single or multiple combinations of the above may be used.

As seen in FIG. 4, for this embodiment of the invention, sample fluid will only enter the flow channel 102 when the level in the mixing chamber 110 rises to a sufficient height. As the blood flows at a controlled rate through the channel 102, the incubation with the analyte in the sample and the label may occur. The mixture then passes to the immobilized antibody chamber 104.

As seen more clearly in FIG. 5, in one embodiment, the immobilized antibody in chamber 104 is located only on the top surface 114 of the chamber. This is particularly useful if whole blood is used with flow cell 100. Since the cells in whole blood can freely pass through the open, non-capillary, dimensions of the flow cell 100, whole blood can be used directly as the sample without cell removal or lysis. None-the-less by immobilizing the antibody at the top of the chamber relative to gravity, only plasma is present in the antibody binding zone due to microscopic settling of the blood cells as they are moved slowly by fluid moving source through the precision, flow channel.

It should be understood, of course, that other embodiments may have immobilized antibody on a bottom surface of the chamber 110, on a side surface, on multiple surfaces, and/or on all surfaces of the chamber 110.

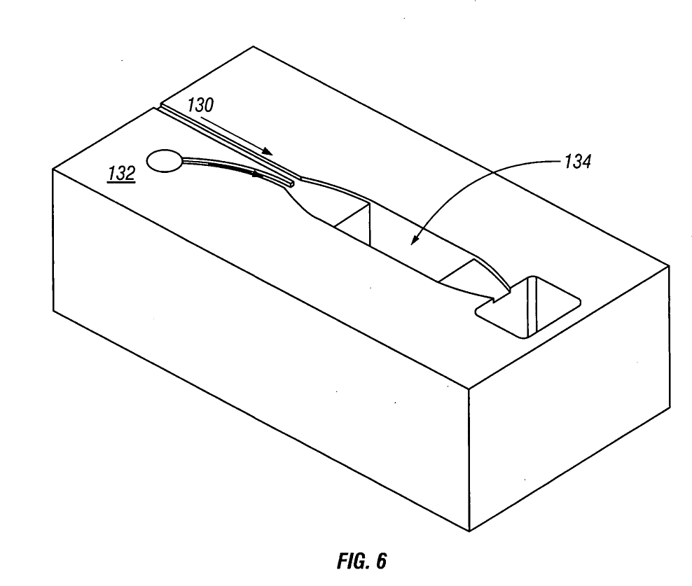

Referring now to FIG. 6, yet another embodiment of the present invention will now be described. This embodiments shows a device with a direct injection port 130 and a label injection port 132. This embodiment allows for introduction of flow to cause mixing. This ability to introduce multiple flows allows for creating a variety of sequential flow options.

In one sequential flow option, after mixed sample/label is flowed past the immobilized antibody chamber 134, a wash buffer may be flowed via the direct injection port 130 to remove sample/label completely and by so doing reduce background interferences.

In another sequential flow option, the sample is flowed directly into the immobilized antibody chamber 134 through the direct injection port 130. A buffer is pumped through the label mixing chamber and carries the label through the label injection port 132 into the immobilized antibody chamber. This has the advantage of a sequential assay wherein, unlike the single flow simultaneous assay, inappropriate saturation of the capture antibody cannot occur which, in turn, avoids an incorrectly low reading.

Using the method described in the preceding paragraph, sample is flowed directly into the immobilized antibody chamber 134 through the direct injection port 130. A buffer is moved through the label mixing chamber and carries the label through the label injection port 132 into the immobilized antibody chamber.

### EXAMPLE 1

Apparatus 10 is used for a sandwich of HCG assay. The HCG is obtained from serum, plasma or urine in a volume of 10 to 100 microliters. The label is monoclonal or polyclonal antibody and is conjugated to the flurophore Texas Red at a ratio between 1-7 of flurophore per antibody. The label is directed to the beta subunit of HCG. 5-500 micrograms of label are utilized. Anti HCG antibody, to the alpha subunit, is immobilized in measurement chamber 19. Flow channel 60 has a volume of from 5-200 microliters.

### EXAMPLE 2

Apparatus 10 is used for the cardiac test marker NT pro-BNP in a sandwich assay. The NT pro-BNP is obtained from serum or plasma, with the cells being separated from whole blood, in a volume of 20 to 200 microliters. Anti-NT pro-BNP antibody is the conjugate and is covalently coupled to polystryene beads that incorporate a deep red fluorescent dye in the 50 microgram to 1 milligram range of dried material. Flow channel 60 has a volume of 100-400 microliters. Anti-NT pro-BNP is immobilized in measurement chamber 19.

### EXAMPLE 3

Apparatus 10 is used in a competitive assay for digoxin. The digoxin is from serum, plasma or saliva, in a volume of 10 to 50 microliters. Anti-digoxin is the immobilized conjugate with deep red fluorescent beads in a total amount of antibody approximately equal on a molar basis to ½ of the maximum digoxin expected in the sample. Flow channel 60 has a volume of 50 to 300 microliters. Measurement chamber 19 includes immobilized digoxin which captures any excess, unreacted label.

### EXAMPLE 4

Apparatus 10 is used in a competitive assay for theophylline. The theophylline is from serum, plasma or saliva in a volume of 500 nanoliters to 5 microliters. The immobilized conjugate used is theophylline coupled to Texas Red at a molar ratio less than the minimum detection limit desired in the assay. Flow channel 60 has a volume of 0 to 50 microliters. Measurement chamber 19 includes immobilized anti-theophylline antibody which captures the labeled and unlabeled theophlline in proportion to their relative ratios.

### EXAMPLE 5

Apparatus 10 is used for a sandwich CK-MB assay. The CK-MB is obtained from serum or plasma in a volume of 20 to 200 microliters. Anti-CK-MB is conjugated to gold sol at a ratio between 1-4 gold sol to antibody. The label is directed to the B subunit of CK-MB. 10-500 micrograms of label are utilized. Anti CK-MB antibody, to the M subunit, is immobilized in measurement chamber 19. Flow channel 60 has a volume of from 50-500 microliters. A reflectometer is used to determine the amount of CK-MB in the sample

### EXAMPLE 6

Apparatus 10 is used for an assay of anti HIV antibody. The volume of serum, plasma or saliva used is 5 to 100 microliters. The label is an HIV peptide conjugated to Texas Red at a total amount invisible to unaided visual detection. The mixture passes through flow channel 60 that has a volume of 25 to 250 microliters. Measurement chamber 19 includes immobilized protein A which captures the antibody/label complex.

### EXAMPLE 7

Apparatus 10 is used for an assay of HbsAg. The HbsAg is obtained from serum, saliva or plasma, in volume of 20 to 200 microliters. Anti-HbsAg antibody is the conjugate and is covalently coupled to polystryene beads that incorporate a deep red fluorescent dye in the 50 microgram to 1 milligram range of dried material. Flow channel 60 has a volume of 100-400 microliters. Anti-HbsAg is immobilized in measurement chamber 19 to capture the HsAg/label complex. A final wash of buffer is utilized to reduce background and enhance sensitivity.

### EXAMPLE 8

Apparatus 10 is used for an assay of HbsAg surface antigen. The HbsAg is obtained from serum or plasma, with the cells being separated from whole blood, in an amount of 20 to 200 microliters. Anti-HbsAg antibody is the conjugate and is covalently coupled to polystryene beads that incorporate a deep red fluorescent dye in the 50 microgram to 1 milligram range of dried material. Flow channel 60 has a volume of 100-400 microliters. Anti-HbsAg is immobilized in measurement chamber 19. A final wash of buffer is utilzied.

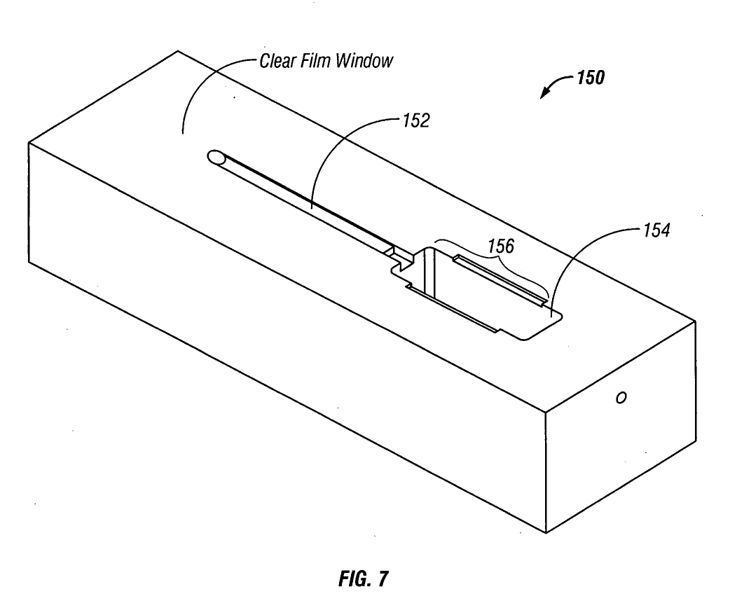

Referring now to FIG. 7, a still further embodiment of a flow cell 150 will now be described. This embodiment discloses a precision flow channel 152 leading to a matrix 154 which may hold an immobilized antibody. The fluorescence area 156 may span the entire matrix 154. Or in some embodiments it may span particular areas. The matrix 154 is similar to that described in FIG. 2 and fluid flows through the matrix instead of over it.

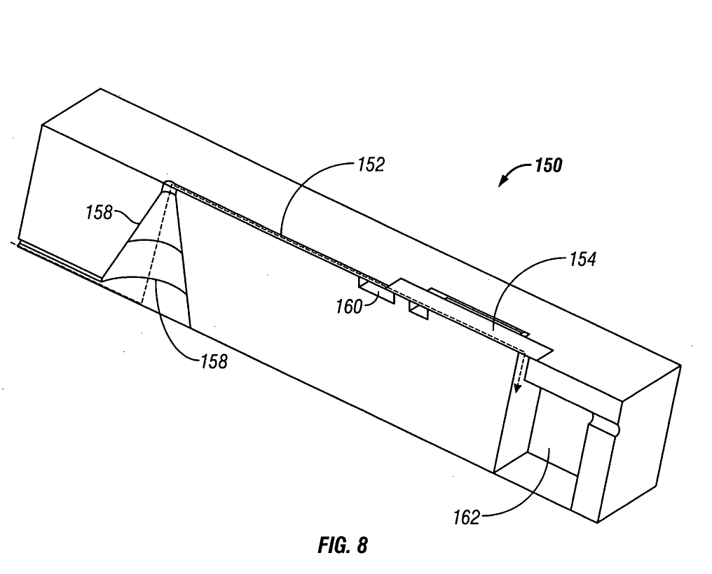

FIG. 8 shows a cross-sectional view of the device of FIG. 7. As seen in FIG. 8, the flow cell 150 may have a vortex mixing chamber 158. Dried label or other material may be on the surface of chamber 158 and mixed with sample fluid in the chamber. Fluid will then flow through the precision flow channel 152 at a flow rate sufficient to provide the desired incubation. The present embodiment may optionally include the flow control chamber 160 to provide further mixing and to allow greater exposure to the surface area of the matrix 154. In some embodiments, the chamber may be located to extend over or above the matrix 154. A sample overflow chamber 162 is provided to allow for fluid to drain therein.

While the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention. For example, with any of the embodiments above, it should be understood that either of the label mixing chamber or the immobilized antibody chamber in this device can be individually substituted for the matrix based counterparts in any other embodiment described herein. A variety of other variations are possible. Some embodiments of the present invention may have a microwell and incubate for a certain time at a certain temperature. Embodiments of the present invention control incubation by flow control meaning that it moves and is ready to be bound after a certain period of flow. The present invention addresses the incubation issue with a fluid moving source as opposed to a timer or a membrane that conducts fluid at a certain rate. Some embodiments may have a thicker membrane and then an end-on flow without substantial overhang of the matrix may be used. By example and not limitation, the membrane may be 10 times thicker than non end-on embodiments.

By example and not limitation, some embodiments of the matrix may use porous plastics material, such as polypropylene, polyethylene (preferably of very high molecular weight), polyvinylidene flouride, ethylene vinylacetate, acrylonitrile and polytetrafluoro-ethylene can be used. It can be advantageous to pre-treat the member with a surface-active agent during manufacture, to reduce hydrophobicity. Porous sample receiving members can also be made from paper or other cellulosic materials, such as nitro-cellulose.

Expected variations or differences in the results are contemplated in accordance with the objects and practices of the present invention. It is intended, therefore, that the invention be defined by the scope of the claims which follow and that such claims be interpreted as broadly as is reasonable.

1. A flow cell configured to be fluidly coupled to a fluid moving source and for use with a monitor device, the flow cell comprising:
a housing;
a mixing chamber;
a flow channel sized to provide for movement of liquid from the mixing chamber by non-capillary action; and
a matrix positioned at a distal end of the flow channel, the matrix containing a compound that will react with the sample to create a change detectable by the monitor device, wherein a fluid path extends from the mixing chamber to the flow channel and to the matrix to bring sample fluid to the matrix for detection of analyte levels therein.

2. The flow cell of claim 1, wherein the mixing chamber is configured to produce a substantially homogenation of label and diluent.

3. The flow cell of claim 2, wherein the diluent is a sample.

4. The flow cell of claim 3, wherein the sample is a fluid.

5. The flow cell of claim 3, wherein the sample is a patient sample indicative of at least one, cardiac, fertility, kidney, coagulation, electrolyte and hematology panel, molecular diagnostics and chemistry panels.

6. The flow cell of claim 1, wherein the flow channel provides a control variation of no more than <10% in flow.

7. The flow cell of claim 1, wherein the matrix is selected from at least one of a polymer surface, a treated polymer surface and a pad.

8. The flow cell of claim 1, wherein the matrix includes a solubilation enhancer.

9. The flow cell of claim 8, wherein the solubilation enhancer is included to facilitate resolution.

10. The flow cell of claim 8, wherein the solubilation enhancer is included to facilitate mixing.

11. The flow cell of claim 8, wherein the solubilation enhancer is selected from at least one of a sugar and surfactant.

12. The flow cell of claim 8, wherein the solubilation enhancer improves stabilization of the label.

13. The flow cell of claim 1, wherein the fluid moving source provides fluid movement by at least one of, pumping, gravity, centrifugal force and pneumatic.

14. The flow cell of claim 1, wherein the monitoring device includes the energy source is selected from, light, RF, ultra-sound, resistive heating, magnetic field and chemical activation.

15. The flow cell of claim 1, wherein the monitoring device includes a sensor.

16. The flow cell of claim 15, wherein the sensor is selected from, a wavelength dependent light detection device, an intensity of light detection device, a perturbation of a magnetic field device and a light emission intensity or duration device

17. The flow cell of claim 1, wherein the monitoring device includes the energy source and the sensor.

18. The flow cell of claim 1, wherein the monitoring device directly monitors a progress of events inside a measurement chamber.

19. The flow cell of claim 18, wherein the events include, entrance of a first solution and displacement of the first solution by wash or second reactive solution.

20. The flow cell of claim 1, wherein the output is light intensity.

21. The flow cell of claim 1, wherein the output is a measurement of wavelength.

22. The flow cell of claim 1, wherein the mixing chamber contains dry reagent.

23. The flow cell of claim 1, wherein the fluid moving source flows fluid along the flow path at a rate sufficient to allow a desired incubation of the sample in the flow channel prior to reaching the matrix.

24. The flow cell of claim 1, wherein the mixing chamber provides turbulent flow.

25. The flow cell of claim 1, wherein the mixing chamber provides at least partial blockage of flow in the flow path of a fluid.

26. The flow cell of claim 1, wherein the mixing chamber is a vortex.

27. The flow cell of claim 1, wherein a dry reagent is on a wall of the mixing chamber.

28. The flow cell of claim 27, wherein the dry agent is sprayed on the wall of the mixing chamber.

29. The flow cell of claim 1, wherein immobilized antibody is located in an immobilized antibody chamber.

30. The flow cell of claim 1 further comprising a sample overflow chamber to receive fluid that has flowed through the area with immobilized antibody, wherein the sample overflow chamber is coupled to the mixing chamber.

31. The flow cell of claim 1, wherein the flow cell is mounted in a larger cartridge.

32. The flow cell of claim 1, wherein the flow cell is coupled to at least one reservoir with a sealed flow path.

33. The flow cell of claim 1, wherein the flow cell is coupled to a reagent or sample reservoir.

34. The flow cell of claim 1, wherein the mixing chamber is located outside of the flow cell.

35. The flow cell of claim 1, wherein the flow channel is sized so that no capillary action will act on fluid that contacts the channel.

36. The flow cell of claim 1, wherein flow through the flow channel is at a rate slower than flow through the mixing chamber.

37. The flow cell of claim 1, wherein flow through the flow channel is at a rate faster than flow through the mixing chamber.

38. The flow cell of claim 1, wherein fluid continues to flow until all label in the mixing chamber is used.

39. The flow cell of claim 1, wherein the fluid moving source draws fluid into the flow cell.

40. The flow cell of claim 1, the fluid delivery device advances fluid into the flow channel.

41. The flow cell of claim 1, wherein when analytes are detected, fluorescence occurs at an area where fluid enters the matrix.

42. A flow cell configured to be fluidly coupled to a fluid moving source and for use with a monitor device, the flow cell comprising:
a housing;
a mixing chamber;
a flow channel; and
a matrix positioned in the mixing chamber; wherein a fluid path extends from the mixing chamber to the flow channel and the flow channel is sized to provide for non-capillary fluid flow.

43. A test device, comprising:
a non-microporous mixing chamber;
a flow channel coupled to the mixing chamber;
a matrix in fluid communication with the flow channel, the matrix containing a compound that will react with the sample to create a change detectable by a monitor device, wherein a fluid path extends from the mixing chamber to the flow channel and to the matrix to bring sample fluid to the matrix for detection of analyte levels.

44. The device of claim 43, wherein the non-micorporous mixing chamber provides turbulent flow of fluid in the non-microporous mixing chamber.

45. The device of claim 43, wherein a dry porous carrier is mixed with the sample in the non-microporous mixing chamber.

46. The device of claim 43, further comprising:
a labelled specific binding reagent and an unlabeled specific binding reagent.

47. The device of claim 46, wherein the labeled and unlabelled specific binding reagents are capable of participating in either a sandwich reaction or a competition reaction in the presence of the analyte.
